(19) United States
(12) Patent Application Publication
(10) Pub. No.: US 2025/0353118 A1
(43) Pub. Date: Nov. 20, 2025

(54) LASER PROCESSING METHOD, PROCESSING PROGRAM, AND CONTROL DEVICE

(71) Applicant: FANUC CORPORATION, Yamanashi (JP)

(72) Inventor: Lei GUO, Yamanashi (JP)

(21) Appl. No.: 18/871,478

(22) PCT Filed: Jun. 29, 2022
(86) PCT No.: PCT/JP2022/026125

§ 371 Date: Dec. 4, 2024

(51) Int. Cl. B23K 26/38

(52) U.S. Cl. CPC B23K 26/38

(57) ABSTRACT

The present invention is a laser processing method for forming a closed-bottom hole by radiating a laser beam onto a workpiece and thereby removing a section of the workpiece. In the laser processing method, the following steps are repeated until the depth of a closed-bottom hole reaches a prescribed depth: a first irradiating step in which when a laser beam is radiated, a combustion-oxidizing gas is sprayed towards the point of irradiation; and a second irradiating step which follows the first irradiating step and in which when a laser beam is radiated, an inert gas is sprayed towards the point of irradiation.

### TECHNICAL FIELD

The present disclosure relates to a laser processing method that forms a bottomed hole by emitting a laser beam onto a workpiece and removing a part of the workpiece.

### BACKGROUND ART

Laser machines, such as laser cutter and laser welder, transmit a processing laser beam output from a laser oscillator to irradiates a workpiece, and moves the processing laser beam and the workpiece relative to each other to thereby perform predetermined processing. When processing is carried out on a thick metal plate by using such a laser machine, it is known that the processing is carried out while injecting a oxidizing gas, such as oxygen, as an assist gas toward an irradiation point of the laser beam for the purposes of deepening a penetration depth at the irradiation point.

When the laser processing is carried out while injecting the oxidizing gas, an oxidation reaction between the metallic material of the metal plate and the oxygen contained in the oxidizing gas is utilized to promote heat generation, thereby achieving deeper penetration. On the other hand, the penetration depth reaches its capacity as the thickness of the metal plate to be processed increases or as a processing speed gets faster, so that the processing may be difficult.

There are laser processing devices for improving the above-described problem as disclosed in Patent Literature 1 and Patent Literature 2, for instance. The laser processing devices disclosed in these literatures emit a laser beam for performing preprocessing while injecting an inert gas immediately before emitting a laser beam for performing main processing to even out the surface of a workpiece, thereby increasing absorptivity of the laser beam for the main processing.

### PRIOR ART DOCUMENT

### Patent Literature

[Patent Literature 1] Japanese Patent Laid-Open Publication No. H11-104879

[Patent Literature 2] Japanese Patent Laid-Open Publication No. 2001-314986

### SUMMARY OF THE INVENTION

### Problems to be Solved by the Invention

The above-described prior arts enable the processing of a thicker workpiece comparing a case where no preprocessing is performed. However, in a case of machining a thick workpiece that requires multiple paths for cutting and drilling or in a case of machining a concave portion, such as a bottomed hole or groove, an oxide film will remain on the surface of the workpiece due to an oxidation reaction occurring during processing by a laser beam.

Such an oxide film has a melting point higher than those of metallic materials of a base material and is formed when molten metal cools down and solidifies, resulting in rough surface that causes the decrease in absorptivity of the laser beam. Thus, in a case where laser processing is carried out repeatedly on the same portion in the multiple paths, there is a problem that a desired penetration depth (processing depth) cannot be achieved due to the oxide film remaining on the workpiece surface which was processed in the last path.

By contrast, in conventional laser processing, laser processing, as preprocessing of machining using an oxidizing gas as an assist gas, is performed while injecting an inert gas, or the laser processing is performed by using mixture of the oxidizing gas and the inert gas, so as to prevent the generation of a residual oxide film after the above-described processing. However, since the assist gas containing the oxidizing gas is used in the final processing in both cases, a problem arises that it is inevitable that the oxide film remains in the bottom after the processing.

Under the circumstances, there is a need for laser processing technology to form a bottomed hole that can obtain a sufficient processing depth and a bottom without any residual oxide film after processing when drilling a hole in which a bottom remains after processing in multiple paths or a concave portion (bottomed hole).

### Means for Solving the Problem

According to an aspect of the present invention, a laser processing method, which irradiates a workpiece with a laser beam to remove a part of the workpiece so as to form a bottomed hole, is specified to repeatedly perform a first irradiation step for injecting a oxidizing gas when emitting the laser beam and a second irradiation step for injecting an inert gas toward an irradiation point when emitting the laser beam, subsequent to the first irradiation step, until the depth of the bottomed hole reaches a predetermined depth.

According to another aspect of the present invention, a processing program, which causes a control device of a laser processing device, which irradiates a workpiece with a laser beam to remove a part of the workpiece to thereby form a bottomed hole, to repeatedly perform the following steps, is specified to cause the control device to perform a first irradiation step of injecting a oxidizing gas toward an irradiation point when emitting the laser beam, and a second irradiation step of injecting an inert gas toward the irradiation point when emitting the laser beam, subsequent to the first irradiation step, until the depth of the bottomed hole reaches a predetermined depth:

According to another aspect of the present invention, a control device that controls an operation of a laser processing device, which irradiates a workpiece with a laser beam to remove a part of the workpiece so as to form a bottomed hole, is specified to include a processing program for controlling the operation of the laser processing device, in which the processing program causes the control device to repeatedly perform a first irradiation step of injecting a oxidizing gas toward an irradiation point when emitting the laser beam and a second irradiation step of injecting an inert gas toward the irradiation point when emitting the laser beam, subsequent to the first irradiation step, until the depth of the bottomed hole reaches a predetermined depth

### Effect of the Invention

According to an aspect of the present invention, a first irradiation step for injecting a oxidizing gas at an irradiation point when emitting a laser beam and a second irradiation step for injecting an inert gas at the irradiation point when emitting the laser beam after the first step are repeatedly carried out until the depth of a bottomed hole reaches a predetermined depth, so as to obtain a sufficient processing depth and a bottom without any residual oxide film after processing.

### BRIEF DESCRIPTION OF THE DRAWINGS

FIG. 1 is a schematic diagram showing a configuration of a laser processing device that includes a control device for executing a laser processing method according to a first embodiment which is a representative example of the present invention;

FIG. 2 is a block diagram showing an example of a configuration of a gas supply mechanism mentioned in FIG. 1;

FIG. 3 is a block diagram showing an example of a configuration of the control device mentioned in FIG. 1;

FIG. 4A is a partial cross-sectional view showing a processing state when a first irradiation step of the laser processing method according to the first embodiment is executed;

FIG. 4B is another partial cross-sectional view showing the processing state when the first irradiation step of the laser processing method according to the first embodiment is executed;

FIG. 5A is a partial cross-sectional view showing a processing state when a second irradiation step of the laser processing method according to the first embodiment is executed;

FIG. 5B is another partial cross-sectional view showing the processing state when the second irradiation step of the laser processing method according to the first embodiment is executed

FIG. 6 is a flowchart showing a control operation performed by a main control unit of the control device according to the first embodiment;

FIG. 7A is a partial cross-sectional view showing a continuous processing state when the laser processing method according to the first embodiment is carried out;

FIG. 7B is another partial cross-sectional view showing the continuous processing state when the laser processing method according to the first embodiment is carried out;

FIG. 7C is another partial cross-sectional view showing the continuous processing state when the laser processing method according to the first embodiment is carried out;

FIG. 7D is another partial cross-sectional view showing the continuous processing state when the laser processing method according to the first embodiment is carried out;

FIG. 8A is a partial cross-sectional view showing a continuous processing state when a laser processing method is carried out according to a second embodiment which is another example of the present invention;

FIG. 8B is another partial cross-sectional view showing the continuous processing state when the laser processing method is carried out according to the second embodiment which is another example of the present invention;

FIG. 9A is a partial top view showing an example of a processing path of a laser beam in the laser processing method according to the second embodiment;

FIG. 9B is another partial top view showing an example of the processing path of the laser beam in the laser processing method according to the second embodiment;

FIG. 10A is a partial top view showing an example of a processing path of a laser beam in a laser processing method according to a variation of the second embodiment;

FIG. 10B is a partial top view showing an example of the processing path of the laser beam in the laser processing method according to another variation of the second embodiment;

FIG. 11A is a partial cross-sectional view showing a continuous processing state when the laser processing method according to the variation of the second embodiment is carried out;

FIG. 11B is a partial cross-sectional view showing the continuous processing state when the laser processing method according to another variation of the second embodiment is carried out;

FIG. 11C is a partial cross-sectional view showing a continuous processing state when a laser processing method according to yet another variation of the second embodiment is carried out;

FIG. 12 is a schematic diagram showing a configuration of a laser processing device that includes a control device for performing a laser processing method according to a third embodiment which is yet another example of the present invention; and

FIG. 13 is a block diagram showing examples of configurations of a processing head and a gas supply mechanism shown in FIG. 12.

### MODE FOR CARRYING THE INVENTION

A description will now be made about embodiments of a laser processing method according to a representative example of the present invention, a processing program for executing the method, and a control device, by referring to the accompanying drawings.

### First Embodiment

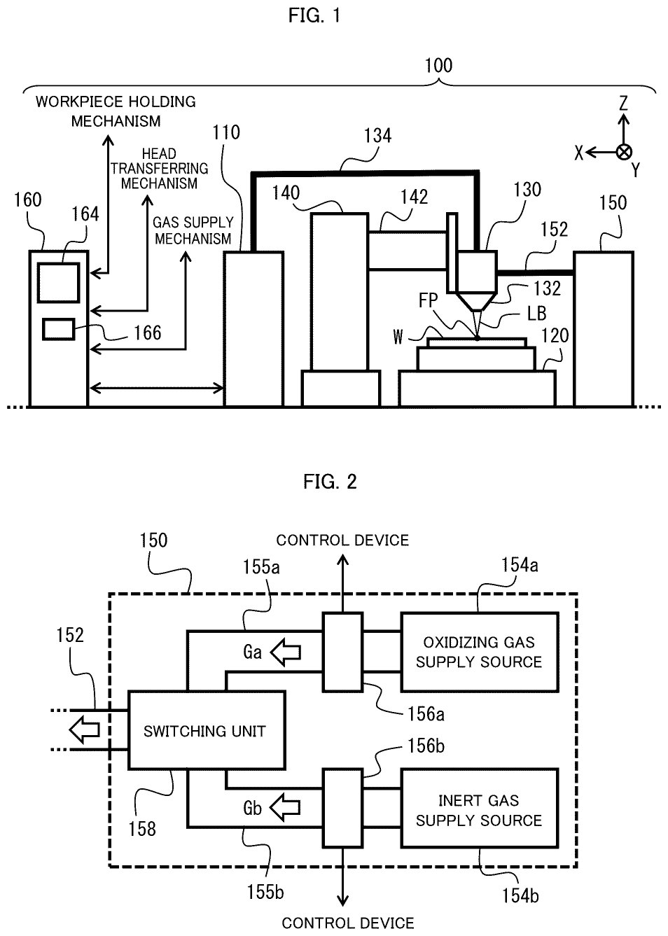

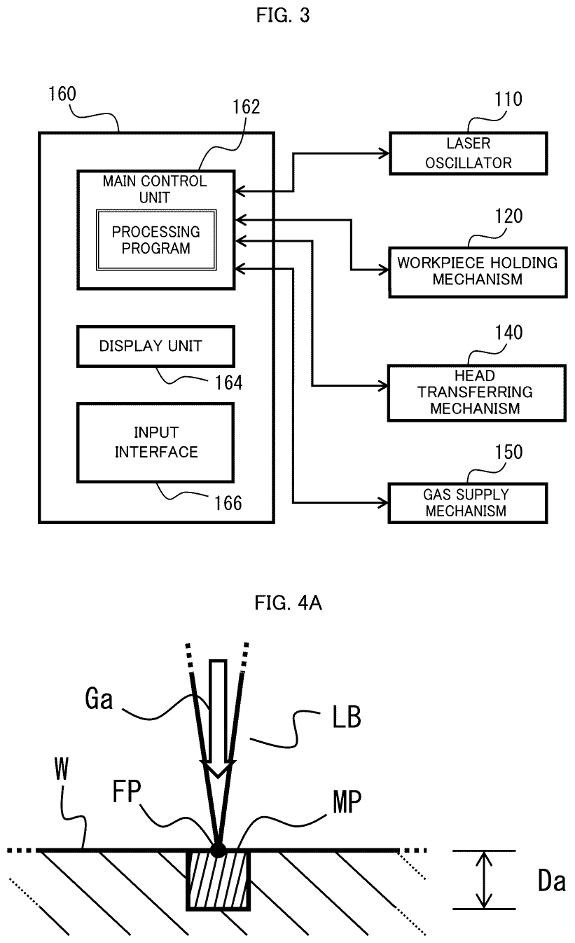

FIG. 1 is a schematic diagram showing a configuration of a laser processing device including a control device for executing a laser processing method according to a first embodiment which is a representative example of the present invention. In addition, FIG. 2 is a block diagram showing an example of the configuration of a gas supply mechanism shown in FIG. 1. Furthermore, FIG. 3 is a block diagram showing an example of the configuration of the control device shown in FIG. 1.

As shown in FIG. 1, the laser processing device 100 includes, by way of example, a laser oscillator 110 that oscillates a laser beam LB for processing, a workpiece holding mechanism 120 that holds a workpiece W, a processing head 130 that irradiates the workpiece W with the laser beam LB, a head transferring mechanism 140 that moves the processing head 130 relative to the workpiece holding mechanism 120, a gas supply mechanism 150 that supplies an assist gas to the processing head 130, and a control device 160 that controls a laser processing operation on the workpiece W based on a processing program.

The laser oscillator 110 uses an oscillation source with a wavelength that has high absorptivity depending on the material of the workpiece W to be processed. For example, the laser oscillator 110 can be one that enables fiber transmission, such as YAG laser, YVO₄ laser, fiber laser, and disc laser. The oscillation of the laser beam LB output from the laser oscillator 110 can be either continuous wave or pulsed wave, and the laser beam LB is transmitted to the processing head 130 through a transmission path 134, such as optical fiber.

The workpiece holding mechanism 120 includes, for instance, a chuck mechanism (not shown) for attaching the workpiece W, and is configured to grip and fix the workpiece W. The workpiece holding mechanism 120 can also include a mechanism for moving the workpiece W in three directions of X, Y and Z as well as a rotating mechanism, for example.

The processing head 130 is configured such that, for example, the laser beam LB is introduced into one end (upper end) of the processing head 130 via the transmission path 134, such as an optical fiber, and is emitted from a nozzle 132 on the other end (lower end) toward the workpiece W. In this case, a condenser lens (not shown) disposed inside the processing head 130 focuses the laser beam LB to a predetermined beam diameter at a focusing point FP on the workpiece W.

Furthermore, the processing head 130 is supplied from a gas supply mechanism 150, about which will be described later, with an assist gas for assisting the laser processing by the laser beam LB with a predetermined pressure and at a predetermined flow rate via a gas supply pipe 152. The assist gas supplied to the processing head 130 is then injected coaxially with the laser beam LB from the nozzle 132.

The head transferring mechanism 140 includes, for instance, a linear driver 142 that moves in three mutually orthogonal directions of X, Y and Z, and the processing head 130 is attached to one end of the linear driver 142. The head transferring mechanism 140 may be constructed as a 6-axis or 7-axis industrial robot that is equipped with a robot arm having the processing head 130 attached on one end.

The gas supply mechanism 150 includes, as an example shown in FIG. 2, a oxidizing gas supply source 154a that stores a oxidizing gas temporarily, an inert gas supply source 154b that stores an inert gas temporarily, supply channels 155a and 155b that guide the supplied oxidizing gas and the supplied inert gas, respectively, pressure sensors 156a and 156b provided to the supply channels 155a and 155b, respectively, and a switching unit 158 that selectively switches the oxidizing gas and the inert gas supplied from the two supply channels 155a, 155b so as to send the selected gas to the gas supply pipe 152. The switching unit 158 includes a switching valve, and is configured to receive supply instructions from the control device 160 and thus send the designated type of gas to the gas supply pipe 152.

In this specification, “oxidizing gas” can be pure oxygen (O₂) gas, oxygen gas containing trace amount of nitrogen (N₂). As to “inert gas”, nitrogen (N₂) gas and helium (He) gas, or argon (Ar) gas can be adopted. In addition, the pressure sensors 156a, 156b shown in FIG. 2 may be flow sensors, for instance.

The control device 160 includes, as an example shown in FIG. 3, a main control unit 162 that outputs a drive command based on a processing program to the components of the laser processing device 100, a display unit 164 that displays various parameters, and an input interface 166 that enables manual input of information for modifying the processing program and the various parameters. Furthermore, in the control device 160, the control unit 162 is connected by wire or wirelessly to the laser oscillator 110, the workpiece holding mechanism 120, the head transferring mechanism 140, and the gas supply mechanism 150, to exchange signals with these peripheral mechanisms for controlling the operation of the entire laser processing device 100.

The main control unit 162 has, for example, a function of extracting information on a processing path and processing conditions from the processing program, and outputting an output command signal to the laser oscillator 110 to instruct to output the laser beam LB. The main control unit 162 also has, for example, a function of extracting information on the position of an irradiation point FP of the laser beam LB and the position of the processing head 130 from the processing program, and outputting a processing position command signal to the workpiece holding mechanism 120 and the head transferring mechanism 140 to instruct the relative movement between the workpiece W and the processing head 130. Furthermore, the main control unit 162 has, for example, a function of extracting information on the type of the assist gas to be injected while emitting and moving the laser beam LB from the processing program, and outputting a gas supply command to the gas supply mechanism 150.

A mode of the laser processing method according to the first embodiment will be described in detail by referring to FIGS. 4A to 7D.

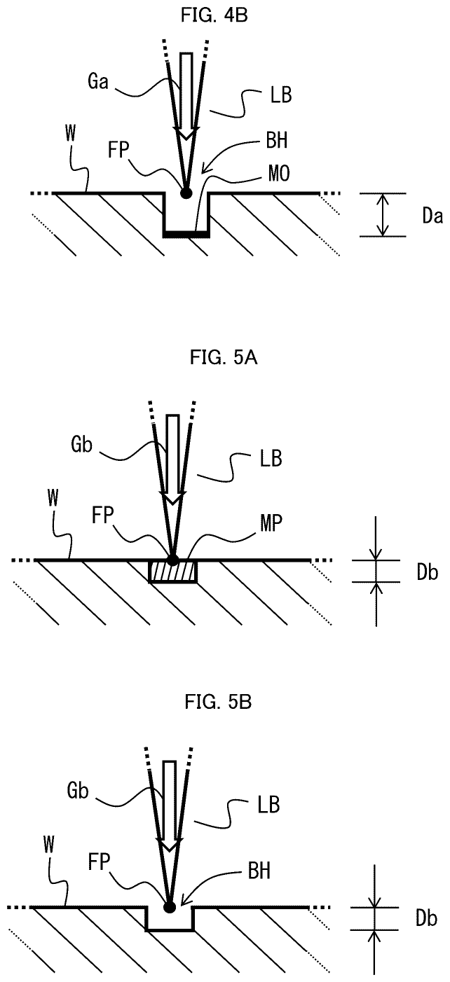

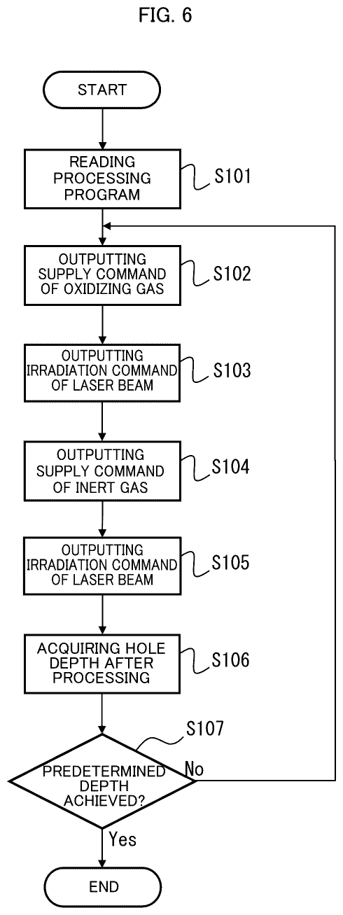

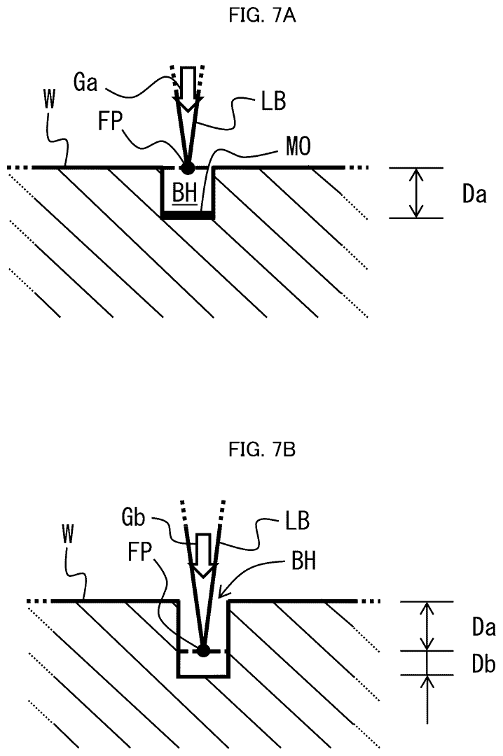

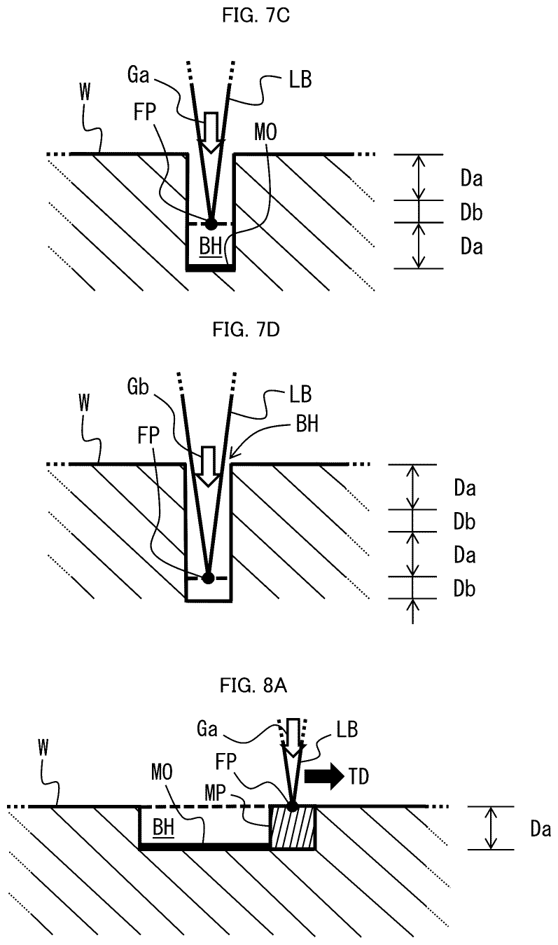

FIGS. 4A and 4B are partial cross-sectional views showing a processing state when a first irradiation step of the laser processing method according to the first embodiment is carried out. FIGS. 5A and 5B are partial cross-sectional views showing a processing state when a second irradiation step of the laser processing method according to the first embodiment is carried out. FIG. 6 is a flowchart showing a control operation performed by the main control unit of the control device according to the first embodiment. FIGS. 7A to 7D are partial cross-sectional views showing a continuous processing state when the laser processing method according to the first embodiment is carried out.

The laser processing method according to the first embodiment repeatedly performs the first irradiation step, in which an oxidizing gas Ga is injected at the irradiation point FP when the laser beam LB is emitted, and the second irradiation step, in which an inert gas Gb is injected at the irradiation point FP when the laser beam LB is emitted, until a bottomed hole BH reaches a predetermined depth. Consequently, a part of the workpiece W is removed, and thereby the bottomed hole BH with the predetermined depth is formed.

In the first irradiation step, as shown in FIG. 4A, the processing is carried out while injecting a high-speed and high-pressure oxidizing gas Ga as an assist gas toward the irradiation point FP of the laser beam LB. The emitted laser beam LB is absorbed into the workpiece W, thereby creating a weld pool MP with a depth Da.

Since the oxidizing gas Ga is injected as the assist gas while emitting the laser beam LB, oxygen contained in the oxidizing gas Ga causes the increase in the temperature of the weld pool, thereby increasing the penetration depth Da. The oxidizing gas Ga injected at the high speed blows the molten weld pool MP away from the workpiece W, and consequently the bottomed hole BH with the depth Da is formed in the workpiece W, as shown in FIG. 4B. In this case, an oxide film MO having a predetermined thickness remains on the bottom surface of the bottomed hole BH due to an oxidation reaction between the workpiece W and the oxidizing gas Ga.

In the second irradiation step, as shown in FIG. 5A, the processing is carried out while injecting a high-speed and high-pressure inert gas Gb as an assist gas toward the irradiation point FP of the laser beam LB. The emitted laser beam LB is absorbed into the workpiece W, thereby creating the weld pool MP with a depth Db.

Since the oxidizing gas Gb is injected as the assist gas while emitting the laser beam LB, the vicinity of the weld pool MP becomes an inert gas atmosphere due to the action of the inert gas Gb, so that an oxidation reaction with the molten workpiece W does not occur. The inert gas Gb injected at the high speed blows the weld pool MP away from the workpiece W, and thus, as shown in FIG. 5B, the bottomed hole BH with the depth Db is formed in the workpiece W. As a consequence, the bottomed hole BH, of which depth is small though, can be obtained with little oxide film MO remaining on the bottom surface.

In the laser processing method according to the first embodiment, which employs the above-described operations in the first irradiation step and the second irradiation step, as shown in FIG. 6, the main control unit 162 of the control device 160 firstly reads the processing program that includes the size and the depth of a bottomed hole to be processed, the emission conditions of the laser beam, and others from, such as, an external database or a storage medium (not shown) (step S101). The main control unit 162 in turn analyzes the processing program thus read out to thereby generate various command signals to be output to the components of the laser processing device 100.

Secondly, the main control unit 162 outputs a supply command signal to the gas supply mechanism 150 to switch to inject the oxidizing gas Ga based on gas supply conditions specified in the processing program (step S102). The main control unit 162 subsequently outputs irradiation command signals to the laser oscillator 110, the workpiece holding mechanism 120 and the head transferring mechanism 140 based on the emission conditions of the laser beam LB (step S103). The operations of the above two steps execute the above-described “first irradiation step” to thereby form the bottomed hole BH with the depth Da in the workpiece W, as shown in FIG. 7A.

Subsequently, the main control unit 162 outputs a supply command signal to the gas supply mechanism 150 to switch to inject the inert gas Gb based on the gas supply conditions specified in the processing program (step S104). The main control unit 162 in turn outputs irradiation command signals to the laser oscillator 110, the workpiece holding mechanism 120 and the head transferring mechanism 140 based on the irradiation conditions of the laser beam LB (step S105). The operations of the above two steps execute the above-described “second irradiation step” to thereby form the bottomed hole BH with the depth (Da+Db) in the workpiece W, as shown in FIG. 7B.

After that, the main control unit 162 acquires the hole depth of the bottomed hole BH formed in the processing performed so far (cumulative total of the depth) (step S106). In the processing performed so far, the cumulative total of the depth is (Da+Db) as described above.

Then, the main control unit 162 determines whether the hole depth of the bottomed hole BH acquired in step S106 reaches the final hole depth specified by the processing program (step S107). When it is determined that the acquired hole depth of the bottomed hole BH reaches the specified hole depth in step S107, the main control unit 162 concludes that the processing of the predetermined bottomed hole BH is completed and thus brings an end to the control operation according to the processing program.

When it is determined that the acquired hole depth of the bottomed hole BH does not reach the specified hole depth in step S107, the main control unit 162 goes back to step S102 to perform the operations in step S102 and the following steps. That is to say, the main control unit 162 outputs the supply command signal for switching the assist gas to the oxidizing gas Ga (step S102), and in turn outputs the irradiation command signals to the laser oscillator 110, the workpiece holding mechanism 120 and the head transferring mechanism 140 (step S103).

In these operations, the first irradiation step is repeated for a second time, and thereby the bottomed hole BH with a depth (2Da+Db) is formed in the workpiece W, as shown in FIG. 7C. In this case, the oxide film MO having a certain thickness remains on the bottom surface of the bottomed hole BH due to the oxidation reaction between the workpiece W and the oxidizing gas Ga.

Then, the main control unit 162 outputs the supply command signal for switching the assist gas to the inert gas Gb (step S104), and in turn outputs the irradiation command signals to the laser oscillator 110, the workpiece holding mechanism 120 and the head transferring mechanism 140 (step S105). The second irradiation step is repeated for a second time in these operations, and thereby the bottomed hole BH with a depth (2Da+2Db), with little oxide film MO remaining, is formed in the workpiece W.

Subsequently, the main control unit 162 acquires the hole depth of the bottomed hole BH formed in the processing performed so far (cumulative total of the depth) (step S106), and determines whether the acquired hole depth of the bottomed hole BH reaches the final depth specified in the processing program (step S107). In step S107 thus carried out repeatedly, when it is determined that the acquired hole depth of the bottomed hole BH reaches the specified hole depth, as with the first case, the main control unit 162 concludes that the processing of the predetermined bottomed hole BH is completed and thus brings an end to the control operation according to the processing program.

When it is determined that the acquired hole depth of the bottomed hole BH does not reach the specified hole depth in step S107, the main control unit 162 goes back to step S102 to perform the second repeated operations in step S102 and the following steps. In this way, the laser processing method according to the first embodiment performs the first irradiation step using the oxidizing gas Ga as the assist gas and the second irradiation step using the inert gas Gb as the assist gas, so as to form the bottomed hole BH with the predetermined depth in the workpiece W.

In this case, when the hole depth of the bottomed hole BH specified in the processing program is not integral multiple of the sum of the processing depth Da in the first irradiation step and the processing depth Db in the second irradiation step, the laser irradiation conditions in the first irradiation step and the second irradiation step, which are carried out repeatedly, may be configured to be adjustable as appropriate. However, the laser irradiation conditions shall be adjusted such that the last process repeatedly carried out in the processing is the process according to the second irradiation step. Thus, the bottomed hole BH with little oxide film MO remaining on its surface is formed in the workpiece W.

With the above-described configuration, the laser processing method according to the first embodiment repeatedly performs the first irradiation step for injecting the oxidizing gas toward the irradiation point when emitting the laser beam, followed by the second irradiation step for injecting the inert gas toward the irradiation point when emitting the laser beam until the depth of the bottomed hole reaches the predetermined depth, thereby obtaining the sufficient processing depth and the bottom on which no oxide film remains after the processing. In this first embodiment, a specific mode of the representative laser processing method according to the present invention has been described. Alternatively, a processing program for performing the steps of the laser processing method by a control device may be employed, and a laser processing device that includes this processing program may be configured to perform the operations of the above-described laser processing method while working as a control device.

### Second Embodiment

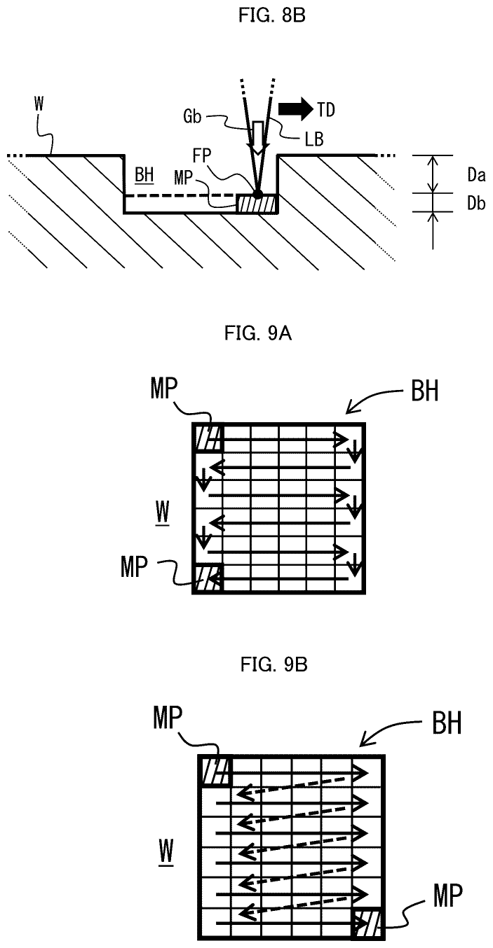

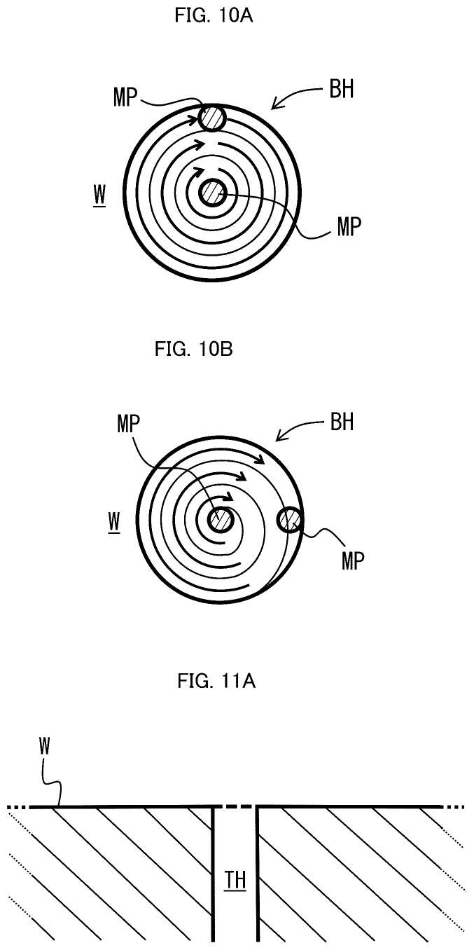

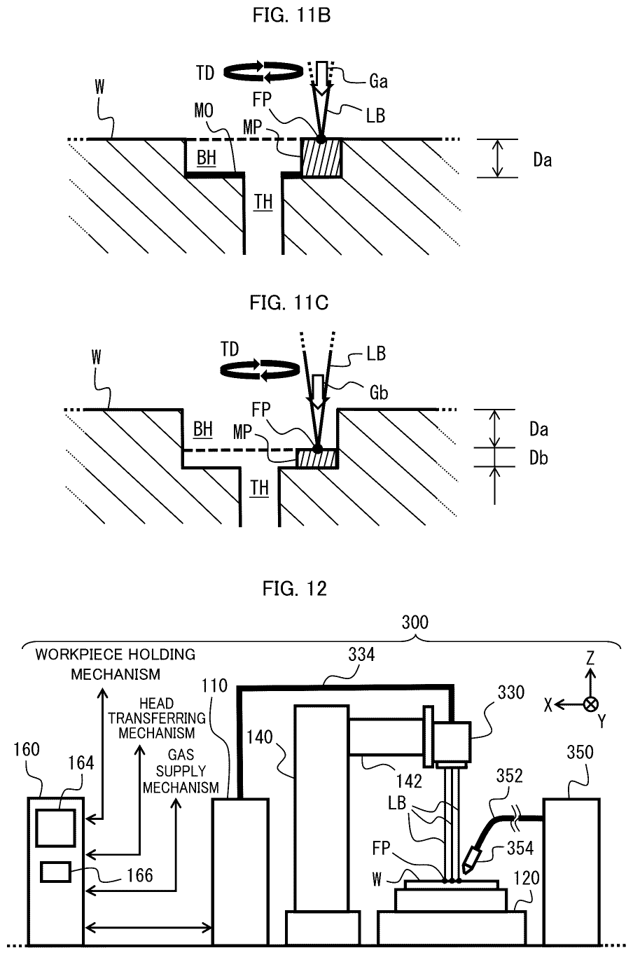

FIGS. 8A and 8B are partial cross-sectional views showing a continuous processing state when the laser processing method according to the second embodiment which is another example of the present invention, is executed. In addition, FIGS. 9A and 9B are partial top views showing examples of a processing path of a laser beam in a laser processing method according to the second embodiment. Furthermore, FIGS. 10A and 10B are partial top views showing examples of a processing path of a laser beam in a laser processing method according to a variation of the second embodiment. Moreover, FIGS. 11A to 11C are partial cross-sectional views showing a continuous processing state when the laser processing method according to the variation of the second embodiment is executed.

In the second embodiment, the constituent elements similar to or adoptable in common with the first embodiment to the schematic diagrams and others shown in FIGS. 1 to 7D are marked with the same reference numerals, and a description about them will not be repeated.

The laser processing method according to the second embodiment performs repeatedly the first irradiation step shown in FIGS. 4A and 4B and the second irradiation step shown in FIGS. 5A and 5B after the first irradiation step while scanning an optical axis of the laser beam LB emitted onto a workpiece W until the depth of a bottomed hole BH reaches a predetermined depth. Thus, a part of the workpiece W that corresponds to the irradiation area by the laser beam LB is removed and thereby the bottomed hole BH with a predetermined depth is formed.

In the first irradiation step, as shown in FIG. 8A, the processing is carried out by scanning the laser beam LB in a predetermined direction TD while injecting a high-speed and high-pressure oxidizing gas Ga as an assist gas toward an irradiation point FP of the laser beam LB. Thus, a weld pool MP having a depth Da is formed at the irradiation point FP of the laser beam LB in the workpiece W, and the weld pool MP is moved by scanning the laser beam LB.

Since the laser beam LB is emitted while injecting the oxidizing gas Ga as the assist gas, the oxidizing gas Ga injected at high speed blows the molten weld pool MP away from the workpiece W, and consequently the bottomed hole BH with the depth Da is formed in a predetermined area in the workpiece W. At this time, an oxide film MO with a predetermined thickness remains on the bottom surface of the bottomed hole BH due to an oxidation reaction between the workpiece W and the oxidizing gas Ga.

In the second irradiation step, as shown in FIG. 8B, the processing is carried out by scanning the laser beam LB in the predetermined direction TD while injecting a high-speed and high-pressure inert gas Gb as an assist gas toward the irradiation point FP of the laser beam LB, overlapping on the area processed in the first irradiation step. Thus, a weld pool MP having a depth Db is formed at the irradiation point FP of the laser beam LB in the workpiece W, and the weld pool MP is moved by scanning the laser beam LB.

Since the laser beam LB is emitted while injecting the oxidizing gas Gb as the assist gas, the inert gas Gb injected at high speed blows the molten weld pool MP away from the workpiece W, and thus the bottomed hole BH with the depth Db is formed in a predetermined area in the workpiece W. Consequently, the bottomed hole BH with little oxide film MO remaining on the bottom surface can be obtained. The laser processing method according to the second embodiment repeats the first irradiation step and the second irradiation step until the hole depth specified in the processing program is achieved, as with the first embodiment.

The procedure of scanning the laser beam in the above-mentioned predetermined area can adopt a mode in which the optical axis of the laser beam LB is moved in approximately zigzag manner from right to left in a rectangular area, as illustrated in FIG. 9A, or a mode in which the optical axis of the laser beam LB is shifted from left to right in the similar rectangular area one row at a time, as illustrated in FIG. 9B. The scanning of the laser beam LB may be set to pass through a straight path as well as a curved path.

For example, as shown in FIG. 10A, the laser beam LB can be scanned in a circumferential path that is concentric circle so that a circular bottomed hole BH is formed. Furthermore, as shown in FIG. 10B, the laser beam LB may be scanned in a spiral path from the center of a circle.

As a specific applicable example of forming the above-described circular bottomed hole BH, a through hole TH having a predetermined inner diameter is formed in the workpiece W as shown in FIG. 11A, for instance, and then the first irradiation step is executed to scan the laser beam LB in a circular area centered on the through hole TH. Thus, the bottomed hole BH with the depth Da is formed that is connected to the through hole TH.

Subsequently, as shown in FIG. 11C, the second irradiation step is carried out to scan the laser beam LB in the same irradiation area (path) as that in the first irradiation step. It removes the oxide film MO remaining in the bottomed hole BH formed in the first irradiation step and forms the bottomed hole BH with the depth (Da+Db) that connects to the through hole TH. The above-described first irradiation step and the second irradiation step are repeated until the hole depth specified in the processing program is achieved, as with the first embodiment.

According to such an applicable example, the bottomed hole BH formed by the laser processing method of the second embodiment can be applied as a countersunk hole used for tightening a bolt head or nut to the workpiece W. In this case, since the bottom surface of the bottomed hole BH is formed as a surface with little oxide file MO remaining by the second irradiation step, it is not necessary to perform finishing after the processing without exposing a blackened design surface due to the oxide film MO.

With the above-described configuration, the laser processing method according to the second embodiment performs the processing by scanning the optical axis of the laser beam in the predetermined area, in addition to the effect described regarding the first embodiment, thereby enabling the formation of a bottomed hole having an arbitrary bottom shape. In particular, a bolt hole or through hole is formed in the workpiece, and a bottomed hole connecting to this hole is formed, so that the formed bottomed hole can be applied as a countersunk hole in which the bottom surface of the bottomed hole is the mounting surface.

### Third Embodiment

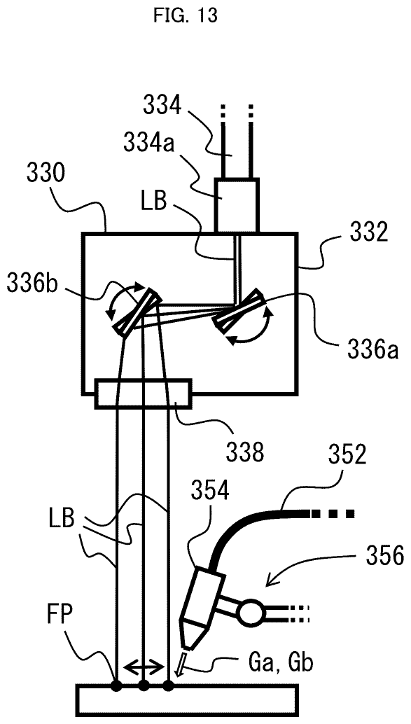

FIG. 12 is a schematic diagram showing a laser processing device that includes a control device for performing a laser processing method according to a third embodiment, which is yet another example of the present invention. Furthermore, FIG. 13 is a block diagram showing an example of a configuration of a processing head and a gas supply mechanism shown in FIG. 12. In the third embodiment, the constituent elements similar to or adoptable in common with the first and second embodiments to the schematic diagrams and others shown in FIGS. 1 to 11C are marked with the same reference numerals, and a description about them will not be repeated.

In the third embodiment, a configuration in which the processing head 130 shown in the first embodiment for coaxially emitting (injecting) the laser beam LB and the assist gas (oxidizing gas Ga, inert gas Gb) from the nozzle is replaced with a scan head 330 for scanning the optical axis of the laser beam LB by means of an optical system, such as a mirror, and a gas injection nozzle 354 for injecting an assist gas toward a irradiation point FP of the laser beam LB. More specifically, as shown in FIG. 12, a laser processing device 300 includes, by way of example, a laser oscillator 110, a workpiece holding mechanism 120, the scan head 330 that scans the optical axis of the laser beam LB in a predetermined area in the workpiece W, a head transferring mechanism 140 that moves the scan head 330 relative to the workpiece holding mechanism 120, a gas supply mechanism 350 that supplies the assist gas toward the irradiation point FP of the laser beam LB emitted onto the workpiece W, and a control device 160 that controls a laser processing operation on the workpiece W based on a processing program.

The scan head 330 includes, as an example shown in FIG. 13, a housing 332, a connector 334a that connects a transmission path 334 to the housing 332, a pair of scan mirrors 336a, 336b that reflect a processing laser beam LB introduced from the connector 334a to set a scan angle for scanning an optical axis of the laser beam LB, and a light condensing optical system 338 that is disposed on the emission side of the scan mirrors 336a, 336b to irradiate the workpiece W with the laser beam W. With this configuration, the laser beam LB emitted from the scan head 330 can move an irradiation point FP of the laser beam LB to any position within a predetermined scanning area, as shown in FIG. 13. The scan head 330 may also have a known configuration, such as a cooling mechanism for cooling various built-in optical systems.

The pair of scan mirrors 336a, 336b includes mirror planes for totally reflecting the laser beam LB, and has a function of moving (scanning) the optical axis of the laser beam LB by oscillating the scan mirrors at a minute angle, by way of example. The scan mirrors 336a, 336b include, for example, a galvano-scanner that pivots a total reflection mirror around a predetermined galvano-motor axis to oscillate it at an arbitrary angle, or a piezoelectric scanner in which the total reflection mirror is attached to an actuator by using a piezoelectric film and the angle of the total reflection mirror is finely adjusted by turning on electricity.

The light condensing optical system 338 is configured to condense the laser beam LB deflected by the pair of scan mirrors 336a, 336b to focus the beam at a predetermined position on the workpiece W, and is structured as a combination of a condenser lens, fθ lens and similar, for instance. Thus, the laser beam LB scanned within a predetermined scanning range enters on the surface of the workpiece W almost perpendicularly. The light condensing optical system 338 also has a function as a lid that seals the inside of the scan head 330.

The gas supply mechanism 350 includes, by way of example, a oxidizing gas supply source 154a, an inert gas supply source 154b, a supply channels 155a and 155b, pressure sensors 156a and 156b, and a switching unit 158 shown in FIG. 2, all of which are not shown in FIG. 13, and further includes a gas supply pipe 352 that guides a gas supplied from the switching unit 158, a gas injection nozzle 354 that is attached to one end of the gas supply pipe 352, and a nozzle moving mechanism 356 that moves the gas injection nozzle 354 to be in arbitrary position and direction.

The nozzle moving mechanism 356 consists of a robot arm with the gas injection nozzle 354 attached at its one end, for instance, and is configured to move the gas injection nozzle 354 based on an irradiation command signal received from a main control unit 162 of a control device 160 so as to direct the injection port of the gas injection nozzle 354 toward an irradiation point FP of the laser beam LB. Thus, an assist gas (oxidizing gas Ga, inert gas Gb) is injected at a required timing toward the irradiation point FP of the scanned laser beam LB.

Since the laser processing device 300 that implements a laser processing method according to the third embodiment uses the scan head 330 for scanning the laser beam LB, it is not necessary to move the scan head 330 significantly, thereby enabling reduction in the size or simplification of the structure of the head transferring mechanism 140. In addition to that, since the laser processing device 300 uses the scan head 330 and the gas supply mechanism 350 for injecting the assist gas at the irradiation point FP of the laser beam LB together, the laser beam LB can be made a so-called long-focus laser, for example, thereby enabling remote processing that scans the laser beam LB at high speed.

With the above-described configuration, the laser oscillator according to the third embodiment can, in addition to the effect described regarding the first embodiment, downsize or simplify the scan head and the head transferring mechanism by using the scan head that enables high-speed scan on the optical axis of the laser beam.

The present invention is not limited to the above-described embodiments, and can be modified as appropriate without departing from the gist of the invention. For example, any constitutional elements in the embodiments of the present invention can be modified, or any constitutional elements in the embodiments can be omitted.

For example, although the specific modes of the laser processing method have been described in the first to third embodiments, it can be interpreted that the present invention includes within the scope of the invention a processing program for causing the control device to execute the laser processing method, and a control device including the processing program or a storage medium for storing the processing program.

### REFERENCE SIGNS LIST

100 Laser Processing Device
110 Laser Oscillator
120 Workpiece Holding Mechanism
130 Processing Head
132 Nozzle
134 Transmission Path
140 Head Transferring Mechanism
142 Linear Driver
150 Gas Supply Mechanism
152 Gas Supply Pipe
154a Oxidizing Gas Supply Source
154b Inert Gas Supply Source
155a, 155b Supply Channel
156a, 156b Pressure Sensor
158 Switching Unit
160 Control Device
162 Main Control Unit
164 Display Unit
166 Input Interface
300 Laser Processing Device
330 Scan Head
332 Housing
334 Transmission Path
334a Connector
336a, 336b Scan Mirror
338 Light Condensing Optical System
350 Gas Supply Mechanism
352 Gas Supply Pipe
354 Gas Injection Nozzle
356 Nozzle Moving Mechanism

1. A laser processing method for forming a bottomed hole by irradiating a workpiece with a laser beam to remove a part of the workpiece, repeatedly performing the following steps until a depth of the bottomed hole reaches a predetermined depth:
a first irradiation step for injecting an oxidizing gas toward an irradiation point when emitting the laser beam; and
a second irradiation step for injecting an inert gas toward the irradiation point when emitting the laser beam, subsequent to the first irradiation step.

2. The laser processing method according to claim 1, wherein the first irradiation step is carried out while moving the irradiation point, and
the second irradiation step is carried out while moving the irradiation point along the same path as that in the first irradiation step.

3. The laser processing method according to claim 2, wherein the irradiation point is moved in the first irradiation step and the second irradiation step by moving a processing head that emits the laser beam.

4. The laser processing method according to claim 2, wherein the irradiation point is moved in the first irradiation step and the second irradiation step by means of a scan head that scans an optical axis of the laser beam.

5. The laser processing method according to claim 3, wherein the irradiation point in the first irradiation step and the second irradiation step is moved in a circumferential or spiral path.

6-15. (canceled)

16. The laser processing method according to claim 4, wherein the irradiation point in the first irradiation step and the second irradiation step is moved in a circumferential or spiral path.

17. A storage medium that stores a processing program that causes a control device of a laser processing device, which forms a bottomed hole by irradiating a workpiece with a laser beam to remove a part of the workpiece, to repeatedly perform the following steps until a depth of the bottomed hole reaches a predetermined depth:
a first irradiation step of injecting an oxidizing gas toward an irradiation point when emitting the laser beam; and
a second irradiation step of injecting an inert gas toward the irradiation point when emitting the laser beam, subsequent to the first irradiation step.

18. The storage medium according to claim 17, wherein the first irradiation step is carried out while moving the irradiation point, and
the second irradiation step is carried out while moving the irradiation point along the same path as that in the first irradiation step.

19. The storage medium according to claim 18, wherein the irradiation point is moved in the first irradiation step and the second irradiation step by moving a processing head that emits the laser beam.

20. The storage medium according to claim 18, wherein the irradiation point is moved in the first irradiation step and the second irradiation step by means of a scan head that scans an optical axis of the laser beam.

21. The storage medium according to claim 19, wherein the irradiation point in the first irradiation step and the second irradiation step is moved in a circumferential or spiral path.

22. The storage medium according to claim 20, wherein the irradiation point in the first irradiation step and the second irradiation step is moved in a circumferential or spiral path.

23. A control device that controls an operation of a laser processing device, which forms a bottomed hole by irradiating a workpiece with a laser beam to remove a part of the workpiece:
the control device includes a processing program that controls the operation of the laser processing device,
wherein the processing program repeatedly performs the following steps until a depth of the bottomed hole reaches a predetermined depth:
a first irradiation step of injecting an oxidizing gas toward an irradiation point when emitting the laser beam; and
a second irradiation step of injecting an inert gas toward the irradiation point when emitting the laser beam, subsequent to the first irradiation step.

24. The control device according to claim 23, wherein the first irradiation step is carried out while moving the irradiation point, and the second irradiation step is carried out while moving the irradiation point along the same path as that in the first irradiation step.

25. The control device according to claim 24, wherein the irradiation point is moved in the first irradiation step and the second irradiation step by moving a processing head that emits the laser beam.

26. The control device according to claim 24, wherein the irradiation point is moved in the first irradiation step and the second irradiation step by means of a scan head that scans an optical axis of the laser beam.

27. The control device according to claim 25, wherein the irradiation point in the first irradiation step and the second irradiation step is moved in a circumferential or spiral path.

28. The control device according to claim 26, wherein the irradiation point in the first irradiation step and the second irradiation step is moved in a circumferential or spiral path.
